(19) United States
(12) Patent Application Publication
(10) Pub. No.: US 2024/0281107 A1
(43) Pub. Date: Aug. 22, 2024

(54) AUGMENTED REALITY MEDIA TIMELINE MANAGEMENT AND INTERACTION SYSTEM AND METHOD

(71) Applicant: Woofy, Inc., New York, NY (US)

(72) Inventor: Arjun Rai, New York, NY (US)

(21) Appl. No.: 18/112,775

(22) Filed: Feb. 22, 2023

(51) Int. Cl. G06F 3/04815; G06F 3/0486; G06T 19/00

(52) U.S. Cl. CPC G06F 3/04815; G06F 3/0486; G06T 19/006; G06Q 50/01

(57) ABSTRACT

A system includes least one processor to retrieve a list of posts from a database, the list of posts comprising a library of available media posts including past posts and scheduled posts, display a view of the list of posts as an augmented reality (AR) view of the list of posts in a timeline as a first layer that displays overlaid on a view from an imaging device that provides a second layer captured by the imaging device in realtime, receive a request that comprises a drag gesture to move the particular post from a current position in the timeline to a future position in the timeline, receive a selection of at least one media network, and schedule the particular post to be published to the least one media network at a particular future time based on the future position in the timeline.

### BACKGROUND

Companies and businesses use social media platforms to market their products and services. Although the social media networks provide the ability to reach customers throughout the world, it can be incredibly difficult to determine when, how, and what to post. In particular, social media marketers may have to determine what to post in a variety of different languages and determine creative ways to engage potential customers.

Additionally, over time as media continues to proliferate, social media marketers may be unable to easily review a robust and growing collection of possibilities. Collaboration and discussion of options with others is also extremely difficult.

It is with these issues in mind, among others, that various aspects of the disclosure were conceived.

### SUMMARY

According to one aspect, an augmented reality media timeline management and interaction system may include at least one client computing device having an augmented reality media timeline management and interaction application and a server computing device having the augmented reality media timeline management and interaction application. The augmented reality media timeline management and interaction application may have access to a library of media posts and broadcasts. The media posts may be social media posts that are associated with at least one social media platform. In one example, the client computing device may have access to the at least one social media platform and at least one account for each of the at least one social media platform. The library of social media posts may include social media posts that have been published over a previous period of time and social media posts that are scheduled to be published for a future period of time.

In one example, a user of the client computing device may view the library of media posts in an augmented reality user interface and interact with the library of media posts. The user may view each of the posts as three-dimensional user interface elements in the augmented reality user interface and interact with each of the posts. As an example, when a user approaches a post in the augmented reality user interface, the post may display additional data and information when the user is within a particular distance from the post. The user may move each of the posts and may place each of the posts on a timeline to be published to one or more media networks at a particular time in the future. As an example, the media post may be scheduled to be published immediately or for a future time.

More than one user may interact with and view the library of media posts in the augmented reality user interface. Each of the users may also communicate with one another in the augmented reality user interface in realtime using audio and/or video.

According to an aspect, a system includes a memory and at least one processor to execute computer-executable instructions to retrieve a list of posts from a database, the list of posts comprising a library of available media posts including past posts and scheduled posts, display a view of the list of posts as an augmented reality (AR) view of the list of posts in a timeline as a first layer that displays overlaid on a view from an imaging device that provides a second layer captured by the imaging device in realtime, each post in the timeline view displayed as a three-dimensional user interface element in the first layer in the augmented reality view, each post having a front side, a right side, a left side, a top side, and a bottom side, the front side displaying content associated with the post, at least one of the front side, the right side, the left side, the top side, and the bottom side of each post in the timeline viewable in a gallery view of the list of posts depending on a particular viewpoint, each post in the list of posts hung on a virtual wall associated with the first layer, receive a selection gesture in the direction of the first layer toward the second layer to select a particular post, receive a request that comprises a drag gesture to move the particular post from a current position in the timeline to a future position in the timeline, the augmented reality view indicating when the post is scheduled to post after a current time by displaying at least one indicator that is pinned to a corner of the three-dimensional user interface element, receive a selection of at least one media network, and schedule the particular post to be published to the least one media network at a particular future time based on the future position in the timeline.

According to another aspect, a method includes retrieving, by at least one processor, a list of posts from a database, the list of posts comprising a library of available media posts including past posts and scheduled posts, displaying, by the at least one processor, a view of the list of posts as an augmented reality (AR) view of the list of posts in a timeline as a first layer that displays overlaid on a view from an imaging device that provides a second layer captured by the imaging device in realtime, each post in the timeline view displayed as a three-dimensional user interface element in the first layer in the augmented reality view, each post having a front side, a right side, a left side, a top side, and a bottom side, the front side displaying content associated with the post, at least one of the front side, the right side, the left side, the top side, and the bottom side of each post in the timeline viewable in a gallery view of the list of posts depending on a particular viewpoint, each post in the list of posts hung on a virtual wall associated with the first layer, receiving, by the at least one processor, a selection gesture in the direction of the first layer toward the second layer to select a particular post, receiving, by the at least one processor, a request that comprises a drag gesture to move the particular post from a current position in the timeline to a future position in the timeline, the augmented reality view indicating when the post is scheduled to post after a current time by displaying at least one indicator that is pinned to a corner of the three-dimensional user interface element, receiving, by the at least one processor, a selection of at least one media network, and scheduling, by the at least one processor, the particular post to be published to the least one media network at a particular future time based on the future position in the timeline.

According to an additional aspect, a non-transitory computer-readable storage medium includes instructions stored thereon that, when executed by a computing device cause the computing device to perform operations, the operations including retrieving a list of posts from a database, the list of posts comprising a library of available media posts including past posts and scheduled posts, displaying a view of the list of posts as an augmented reality (AR) view of the list of posts in a timeline as a first layer that displays overlaid on a view from an imaging device that provides a second layer captured by the imaging device in realtime, each post in the timeline view displayed as a three-dimensional user interface element in the first layer in the augmented reality view, each post having a front side, a right side, a left side, a top side, and a bottom side, the front side displaying content associated with the post, at least one of the front side, the right side, the left side, the top side, and the bottom side of each post in the timeline viewable in a gallery view of the list of posts depending on a particular viewpoint, each post in the list of posts hung on a virtual wall associated with the first layer, receiving a selection gesture in the direction of the first layer toward the second layer to select a particular post, receiving a request that comprises a drag gesture to move the particular post from a current position in the timeline to a future position in the timeline, the augmented reality view indicating when the post is scheduled to post after a current time by displaying at least one indicator that is pinned to a corner of the three-dimensional user interface element, receiving a selection of at least one media network, and scheduling the particular post to be published to the least one media network at a particular future time based on the future position in the timeline.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a block diagram of a system for augmented reality media timeline management and interaction according to an example of the instant disclosure.

FIG. 2A shows a two-dimensional block diagram of an example of user interface associated with an augmented reality media timeline management and interaction application according to an example of the instant disclosure.

FIG. 2B shows another representation of the example of the user interface associated with the augmented reality media timeline management and interaction application according to an example of the instant disclosure.

FIG. 3 shows a block diagram of a client computing device of the augmented reality media timeline management and interaction system according to an example of the instant disclosure.

FIG. 4 illustrates an example method for scheduling a particular post to be published to at least one media network in augmented reality according to an example of the instant disclosure.

FIG. 5 illustrates an example user interface of the augmented reality media timeline management and interaction application displayed by a client computing device according to an example of the instant disclosure.

FIG. 6 illustrates an example user interface of the application displayed by the client computing device according to an example of the instant disclosure.

FIG. 7 illustrates an example user interface of the application displayed by the client computing device according to an example of the instant disclosure.

FIG. 8 illustrates an example user interface of the application displayed by the client computing device according to an example of the instant disclosure.

FIG. 9 illustrates an example user interface of the application displayed by the client computing device according to an example of the instant disclosure.

FIG. 10 illustrates an example user interface of the application displayed by the client computing device according to an example of the instant disclosure

FIG. 11 illustrates an example user interface of the application displayed by the client computing device according to an example of the instant disclosure.

FIG. 12 illustrates an example user interface of the application displayed by the client computing device according to an example of the instant disclosure.

FIG. 13 shows an example of a system for implementing certain aspects of the present technology according to an example of the instant disclosure.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Aspects of a system and method for scheduling a particular post to be published to at least one media network in augmented reality may include one or more client computing devices having an augmented reality media timeline management and interaction application and one or more server computing devices having an augmented reality media timeline management and interaction application. A user of one of the client computing devices may retrieve a library of media posts and the client computing device may display the library of media posts as a viewable wall of posts in one of augmented reality (AR), mixed reality (MR), extended reality (XR), and virtual reality (VR). The wall may be a curved wall of posts such as one seen in an art gallery and in one example, when the user moves within a particular distance of a post, the post may display additional detail associated with the post in the augmented reality user interface such as a representation of an image associated with the post, a clip of a video associated with the post, and text associated with the post. The user may select one or more of the posts using an augmented reality user interface and move the one or more posts to a particular section of the augmented reality user interface to schedule the one or more posts to be published to one or more media networks at a time in the future.

Social media platforms, websites, and networks provide a way for businesses and individuals to promote products and services. In many cases, the businesses and individuals may use the social media networks at very low cost, often free. As an example, a business may have a team of marketers that are tasked with social media marketing. However, in other cases, a small business may include a very small number of employees or workers, e.g., one worker, that develops and sells a product or service and is also tasked with marketing the product or service. It may be difficult for the small business to compete with a large team of marketers that are tasked with social media marketing.

In many cases, it may be desirable to publish similar messages and social media posts on multiple social media networks simultaneously and/or contemporaneously. The small business may wish to publish one or more social media posts that are related to a same or similar topic or subject over a particular period of time and the small business may wish to reuse the one or more social media posts to create a marketing campaign to blast out similar or related content over a period of time. In one example, it may be desirable to create one or more posts to publish on one or more media networks such as social media networks or smart speaker media networks, among others.

Platforms and networks may authorize another application and/or server computing device to access the social media platforms and networks on their behalf. As an example, the application and/or server computing device may have access using OAuth. OAuth is a protocol for authorization and allows a third-party application to obtain limited access to a Hypertext Transfer Protocol (HTTP) service on behalf of a resource owner by allowing an approval interaction between the resource owner and the HTTP service or by allowing the third-party application to have access on its own. As an example, OAuth allows a user to grant a third-party website or web service access to another website or web service without providing a password. As an example, the user may provide their username or handle and OAuth may grant access. As a result, a social media network such as INSTAGRAM, TWITTER, or FACEBOOK, among others, may permit a user to share information about their account with a third party application or website. The system for determining content similarity may use OAuth or another protocol for authorization to allow access to one or more social media platforms and/or accounts.

However, over time, a business or other entity may generate a robust library of media posts and it may be desirable to be able to easily review and view available media posts in the library. Currently, this is difficult to do so. It is desirable to be able to view the available media posts in the library in a three-dimensional augmented reality view that can allow more than one user to jointly view the media posts and discuss how to manage and interact with the media posts in the library. As an example, each user may view the media posts in three-dimensional space in the augmented reality user interface jointly and communicate in realtime while moving and manipulating the media posts in the library. Each user also may manage and schedule the media posts to be published to one or more platforms in the future and may see each user interacting with the media posts in the augmented reality user interface in realtime.

In one example, the system includes a memory and at least one processor to execute computer-executable instructions to retrieve a list of posts from a database, the list of posts comprising a library of available media posts including past posts and scheduled posts, display a view of the list of posts as an augmented reality (AR) view of the list of posts in a timeline as a first layer that displays overlaid on a view from an imaging device that provides a second layer captured by the imaging device in realtime, each post in the timeline view displayed as a three-dimensional user interface element in the first layer in the augmented reality view, each post having a front side, a right side, a left side, a top side, and a bottom side, the front side displaying content associated with the post, at least one of the front side, the right side, the left side, the top side, and the bottom side of each post in the timeline viewable in a gallery view of the list of posts depending on a particular viewpoint, each post in the list of posts hung on a virtual wall associated with the first layer, receive a selection gesture in the direction of the first layer toward the second layer to select a particular post, receive a request that comprises a drag gesture to move the particular post from a current position in the timeline to a future position in the timeline, the augmented reality view indicating when the post is scheduled to post after a current time by displaying at least one indicator that is pinned to a corner of the three-dimensional user interface element, receive a selection of at least one media network, and schedule the particular post to be published to the least one media network at a particular future time based on the future position in the timeline.

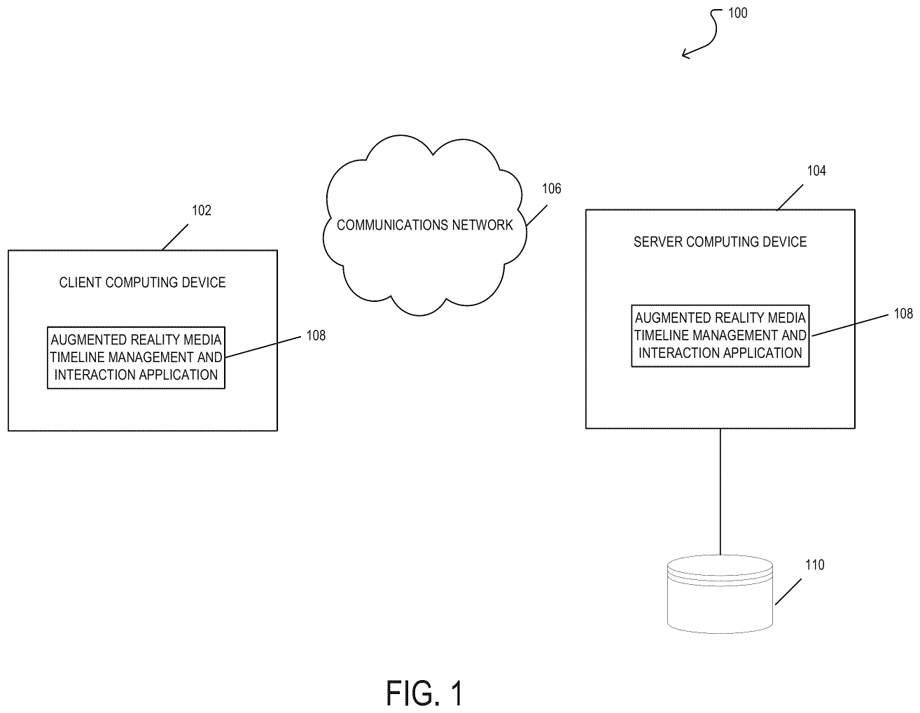

FIG. 1 shows a block diagram of a computing system comprising an augmented reality (AR) media timeline management and interaction system 100 according to an example of the instant disclosure. The AR media timeline management and interaction system 100 includes at least one client computing device 102 that is in communication with at least one server computing device 104 via a communication network 106. The at least one client computing device 102 may have an application or at least one component of an application, e.g., an augmented reality media timeline management and interaction application 108. In addition, the at least one server computing device 104 may have an application or at least one component of an application, e.g., an augmented reality media timeline management and interaction application 108.

The at least one client computing device 102 is configured to receive data from and/or transmit data to the at least one server computing device 104 through the communication network 106. Although the at least one client computing device 102 is shown as a single computing device, it is contemplated that the at least one client computing device 102 may include multiple computing devices.

The communication network 106 can be the Internet, an intranet, or another wired or wireless communication network. For example, the communication network 106 may include a Mobile Communications (GSM) network, a code division multiple access (CDMA) network, 3^{rd} Generation Partnership Project (GPP) network, an Internet Protocol (IP) network, a wireless application protocol (WAP) network, a WiFi network, a Bluetooth network, a satellite communications network, or an IEEE 802.11 standards network, as well as various communications thereof. Other conventional and/or later developed wired and wireless networks may also be used.

The at least one client computing device 102 includes at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions such as a portion or component of the augmented reality media timeline management and interaction application 108. In addition, the at least one client computing device 102 further includes at least one communications interface to transmit and receive communications, messages, and/or signals.

The at least one server computing device 104 includes at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions such as a portion or a component of the augmented reality media timeline management and interaction application 108. In addition, the at least one server computing device 104 further includes at least one communications interface to transmit and receive communications, messages, and/or signals.

The at least one client computing device 102 can be a laptop computer, a smartphone, a personal digital assistant, a tablet computer, a standard personal computer, or another processing device. The at least one client computing device 102 may include a display, such as a computer monitor, for displaying data and/or graphical user interfaces. The at least one client computing device 102 may also include an input device, such as one or more cameras, a keyboard or a pointing device (e.g., a mouse, trackball, pen, or touch screen) to enter data into or interact with graphical and/or other types of user interfaces. In an example, the display and the input device may be incorporated together as a touch screen of the smartphone or tablet computer. Additionally, the at least one computing device 102 may include a Global Positioning System (GPS) hardware device for determining a particular location of the client computing device 102, one or more accelerometers, and one or more magnetometers, one or more LiDAR sensors, Bluetooth hardware devices, and near-field communication (NFC) hardware devices, among others.

The at least one client computing device 102 may display on the display a graphical user interface (or GUI). The graphical user interface may be provided by the augmented reality media timeline management and interaction application 108. The graphical user interface enables a user of the at least one client computing device 102 to interact with the augmented reality media timeline management and interaction application 108 and select from a library of media in augmented reality and schedule one or more posts in augmented reality with one or more users in realtime. In addition, the user is able to create and schedule one or more media posts or briefings that may be scheduled to be transmitted, sent, or broadcast. The media post or briefing may be based on text and content that may include one or more words, one or more hashtags, one or more emojis, one or more quotations, and one or more images, among other content. The text may include one or more uniform resource locators (URLs). The media post or briefing also may be generated based on one or more audio or video files that the user may select and upload using the augmented reality media timeline management and interaction application 108.

The augmented reality media timeline management and interaction application 108 may be a component of an application and/or service executable by the at least one client computing device 102. For example, the augmented reality media timeline management and interaction application 108 may be a single unit of deployable executable code or a plurality of units of deployable executable code. According to one aspect, the augmented reality media timeline management and interaction application 108 may include one component that may be a web application, a native application, and/or a mobile application (e.g., an app) downloaded from a digital distribution application platform that allows users to browse and download applications developed with mobile software development kits (SDKs) including the App Store and GOOGLE PLAY®, among others.

The system 100 may also include a relational database management system (RDBMS) or another type of database management system such as a NoSQL database system that stores and communicates data from at least one database. The data stored in the at least one database may be associated with a library of media posts or briefings to be published to one or more media platforms such as one or more social media platforms. The library of media posts may include one or more of a plurality of draft media posts, a number of media posts that have been published, and a number of media posts that have been scheduled to publish. In addition, the data stored in the at least one database may include information associated with the media posts including statistical and analytical information associated with the media posts. As an example, the database may include one or more tables or data structures that may be organized to store the information associated with the database.

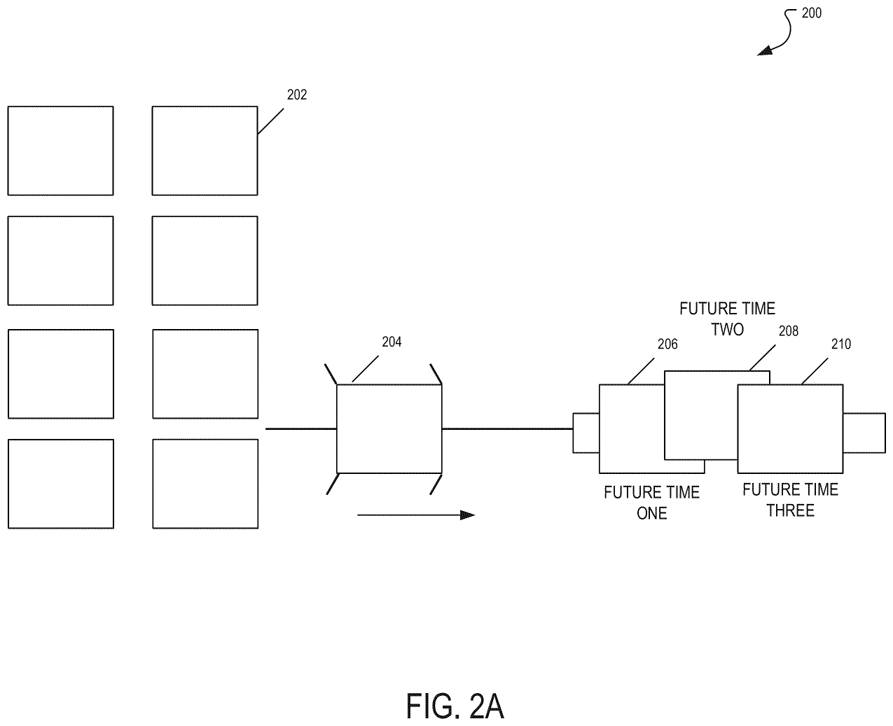

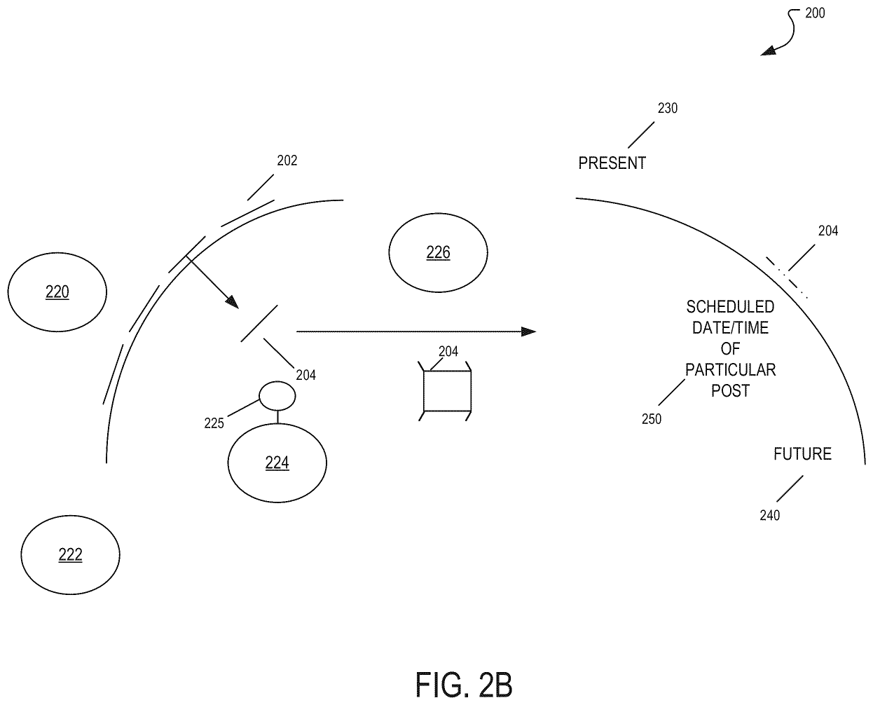

FIG. 2A illustrates a block diagram of an augmented reality user interface 200 that allows a user to view one or more pieces of media in a library 202 and select the one or more pieces of media to be scheduled to be posted to one or more media platforms such as a social media platform. As shown in FIG. 2, a particular piece of media 204 is selected and is being moved from a position in the library 202 from a first direction, e.g., a left side of the augmented reality user interface, to a second direction, e.g., a right side of the augmented reality user interface. It is possible that the direction of movement could be in a different direction such as from the right to the left, from a bottom to a top, and from a top to a bottom, among other directions. As the particular piece of media 204 is being moved, one or more graphical indications may indicate an acceleration of the particular piece of media. In this case, the particular piece of media is moving from the left to the right and thus the one or more graphical indications are shown as tails or appendages that are moving toward the first direction, e.g., the left. The tails or appendages may appear as if they are swaying or blowing in the wind in the augmented reality user interface. In addition, there is a first piece of media 206 that is scheduled to be posted, a second piece of media 208 that is scheduled to be posted, and a third piece of media 210 that is scheduled to be posted. Each of the first piece of media 206, the second piece of media 208, and the third piece of media 210 may be moved, placed, or relocated to right side (or another side) of the user interface to be scheduled to be posted in the future after a current time. When a user moves a particular piece of media to the right side, the particular piece of media may be highlighted to indicate that it is scheduled to be published at a time after a current time, e.g., in the future. The highlighting may be in a particular color. Each piece of media may appear as a different layer on top of or partially obstructing another piece of media, especially depending upon a viewpoint of the user in the augmented reality user interface. In addition, the augmented reality user interface may indicate a date and/or time in the future associated with a publication of the particular piece of media.

FIG. 2B shows another representation of the block diagram of the example of the user interface 200 associated with the augmented reality media timeline management and interaction application according to an example of the instant disclosure. This view may represent a three-dimensional view of the augmented reality view that is shown from above. As shown in FIG. 2B, the one or more pieces of media in the library 202 are shown along a first curved wall. The user may select the particular piece of media and when it is selected it may move toward a viewpoint of a user. The user may drag or pull the particular piece of media toward a present time and into a future time to be scheduled to be published on one or more media networks or platforms. As shown in FIG. 2B, a left side of the augmented reality user interface may include a second curved wall that may have a present time 230 on a left side of the second curved wall and time that is later than the present time 230 or future time 240 that is on the right side of the curved wall. As the user drags or pulls the particular piece of media 204 past a present time 230 on the second curved wall the particular piece of media may be highlighted as being scheduled to be published at a future time. The particular piece of media may be highlighted in a particular color and a date and/or time 250 may be displayed that may indicate when the particular piece of media would be scheduled to be published if the user stopped moving the particular post. When the user stops moving the particular post, it may be scheduled to be published at the date and/or time.

As shown in FIG. 2B, there are four user interface elements 220, 222, 224, and 226 that indicate a particular position of a user and a client computing device 102 associated with the user. Each user may have a different viewpoint of the augmented reality user interface. As an example, a first user 220 may see a rear view of the one or more pieces of media in the library 202. Another user or a second user 222 may be within a particular distance of a particular piece of media and may see additional detail associated with the particular piece of media. The second user also may view a side view of the one or more pieces of media in the library 202. As an example, the second user may see a video clip that may play and audio may be provided only to the second user and the client computing device of the second user. A third user 226 may have a different viewpoint of the one or more pieces of media in the library. A fourth user 224 may have a front view and may be selecting the particular piece of media 204, dragging the particular piece of media from the first curved wall and toward the second curved wall to schedule the particular piece of media to be published at the scheduled date/time. As shown in FIG. 2B, the fourth user 224 may direct or point their user interface element 225 toward the particular piece of media 204 and may select the particular piece of media 204 by touching the particular piece of media 204 on their touchscreen of the client computing device 102. The user may move the particular piece of media 204 from the first curved wall to the second curved wall by maintaining the touch on the touchscreen and moving the client computing device 102 in a direction from the first curved wall to the second curved wall, e.g., from left to right. The particular piece of media may be removed from a current position in the library 202 on the first curved wall and brought toward a viewpoint of the user. As the particular piece of media is moving, there may be tails or appendages that may be displayed on each corner of the particular piece of media 204. A size of each of the tails or appendages may be based on an acceleration of the particular piece of media. As the particular piece of media 204 moves from a present time on the second curved wall to a future time, the particular piece of media may be highlighted to indicate that it can be scheduled to be published at a future date/time 250. Alternatively, the one or more tails or appendages may be shown in a particular color to indicate that it can be scheduled to be published at a future date/time 250.

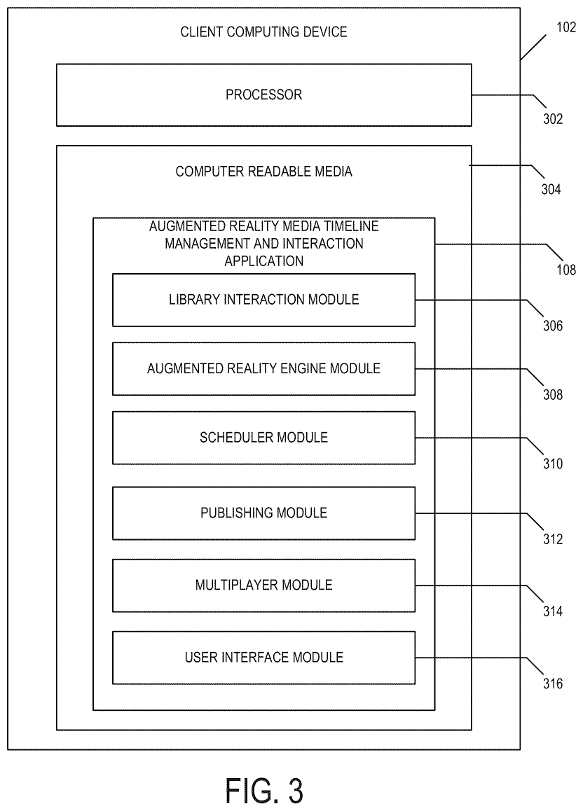

FIG. 3 illustrates a block diagram of the client computing device 102 according to an example of the instant disclosure. The client computing device 102 includes at least one processor 302 and computer readable media (CRM) 304 in memory on which the augmented reality media time management and interaction application 108 or other user interface or application is stored. The computer readable media 304 may include volatile media, nonvolatile media, removable media, non-removable media, and/or another available medium that can be accessed by the processor. By way of example and not limitation, the computer readable media comprises computer storage media and communication media. Computer storage media includes non-transitory storage memory, volatile media, nonvolatile media, removable media, and/or non-removable media implemented in a method or technology for storage of information, such as computer/machine-readable/executable instructions, data structures, program modules, or other data. Communication media may embody computer/machine-readable/executable instructions, data structures, program modules, or other data and include an information delivery media or system, both of which are hardware.

The augmented reality media time management and interaction application 108 may include a library interaction module 306 that sends a request for one or more media posts in a library of a user of the augmented reality media time management and interaction application 108. The one or more media posts or information associated with the one or more media posts may be stored in the database 110. The library interaction module 306 may retrieve data and information associated with the one or more media posts for display in an augmented reality user interface.

Each media post may be created by a user and may include text entered by a user, one or more URLs, one or more hashtags, one or more emojis, and one or more audio or video files, among other data and information.

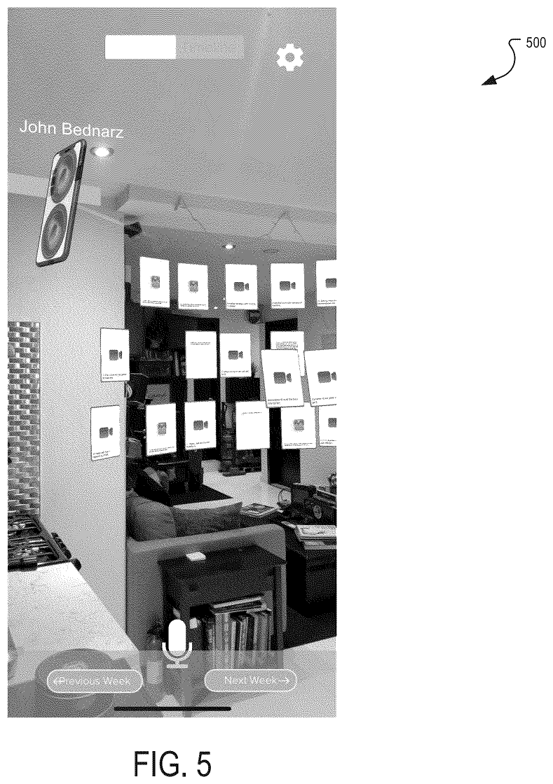

The augmented reality media time management and interaction application 108 may include an augmented reality engine module 308 for generating and supporting an augmented reality view of the one or more posts in the library of the user as shown in FIG. 2 and in FIGS. 5-12. As an example, the augmented reality engine module 308 may be associated with one or more augmented reality software development kits (SDKs) as well as one or more augmented reality APIs. In one example, the augmented reality engine module 308 may utilize DecpAR. As an example, upon loading the one or more media posts in a library of a user, the augmented reality engine module 308 may perform staging to generate an augmented reality representation of the library of the user. As an example, the augmented reality engine module 208 may generate a view of the list of posts as an augmented reality (AR) view of the list of posts in a timeline as a first layer that displays overlaid on a view from an imaging device that provides a second layer captured by the imaging device in realtime, each post in the timeline view displayed as a three-dimensional user interface element in the first layer in the augmented reality view, each post having a front side, a right side, a left side, a top side, and a bottom side, the front side displaying content associated with the post, at least one of the front side, the right side, the left side, the top side, and the bottom side of each post in the timeline viewable in a gallery view of the list of posts depending on a particular viewpoint, each post in the list of posts hung on a virtual wall associated with the first layer.

The augmented reality media time management and interaction application 108 may include a scheduler module 310 to schedule media posts to be published to one or more media networks. As noted herein, a user may select one or more posts from the library and may move the one or more posts from a first position in the augmented reality user interface to another position in the augmented reality user interface to schedule the post to be published to one or more platforms. As an example, the augmented reality engine module 308 may display each post in the list of posts hung on the virtual wall associated with the first layer on a first three-dimensional curved wall and receive the request to move the particular post from a fixed position on the first three-dimensional curved wall to the future position on a second three-dimensional curved wall. Upon moving the particular post to the future position, the scheduler module 310 may allow the user to provide and schedule one or more posts to one or more social media networks and platforms including, but not limited to, FACEBOOK, TWITTER, SNAPCHAT, LINKEDIN, TIKTOK, PINTEREST, REDDIT, SHOPIFY, WORDPRESS, TUMBLR, BLOGGER, YOUTUBE, TWITCH, DRIBBBLE, TELEGRAM, WHATSAPP, SLACK, MESSENGER, GOOGLE, and INSTAGRAM. The particular post also may be a briefing to be broadcast to users associated with a network of smart speakers. The user may save the briefing as a draft or may post the briefing to be scheduled to be transmitted, sent, or broadcast at a particular time or be transmitted, sent, or broadcast now, e.g., in real time.

The particular post may include text entered by a user, one or more URLs, one or more hashtags, one or more emojis, and one or more audio or video files. In one example, the scheduler module 310 may send a representation of the post to another server computing device using an AMAZON ALEXA Skills Kit (ASK) and/or another SDK or API to convert the representation of the post into a format for presentation by the smart speaker media network. As an example, the text found at the one or more URLs, the one or more hashtags, the one or more emojis, and the one or more audio or video files may be converted into audio and/or video to be played by the smart speaker devices associated with the smart speaker media network. As an example, the scheduling module 310 may parse the data associated with the post to convert text, text found at the URLs, hashtags, or the emojis into audio and/or video to be played by the smart speaker devices.

The augmented reality media time management and interaction application 108 may include a publishing module 312 to publish the media posts to be published to the one or more media networks. As an example, when a user schedules a post to be published, the publishing module 312 may allow the user to select one or more media networks to simultaneously publish the post. As an example, the user may select one or more social media networks and may input a time to publish the post, e.g., 01/01 at 12:00. In addition, the user may select one or more smart speaker media networks to broadcast information associated with the post.

The publishing module 312 may be associated with a number of social media login and authentication information that may include representations of usernames and passwords provided to the server computing device 104 for a number of social media platforms or smart speaker media networks and accounts including, but not limited to, FACEBOOK, TWITTER, SNAPCHAT, LINKEDIN, TIKTOK, PINTEREST, REDDIT, SHOPIFY, WORDPRESS, TUMBLR, BLOGGER, YOUTUBE, TWITCH, DRIBBBLE, TELEGRAM, WHATSAPP, SLACK, MESSENGER, GOOGLE, and INSTAGRAM. The one or more briefings may be scheduled to be posted to separately from the media posts or be posted to coincide, in conjunction with, or simultaneous with the social media posts. As a result, the publishing module 312 is able to simultaneously or nearly simultaneously publish the media post to one or more media networks and/or the smart speaker media networks using the login and authentication information.

The augmented reality media time management and interaction application 108 may include a multiplayer module 314 that provides networking services that allow more than one client computing device 102 and more than one user to interact with the library of media posts 202 simultaneously. The multiplayer module 314 may allow simultaneous communication between the more than one user via audio and/or video. In addition, the multiplayer module 314 may be used to simultaneously send each user a same view of the augmented reality view and send a particular location of each user in the augmented reality view as they are interacting with the library of media posts 202. All of the user interactions are also sent simultaneously and viewable by each user using the multiplayer module 314.

In addition, the augmented reality media timeline management and interaction application 108 includes a user interface module 316 for displaying the user interface on the display of the client computing device 102. The user interface module 316 may operate in conjunction and/or in tandem with the augmented reality engine module 308. As an example, the user interface module 316 generates a native and/or web-based graphical user interface (GUI) that accepts input and provides output viewed by a user of the client computing device 102. The client computing device 102 may provide realtime automatically and dynamically refreshed information such as an AR view of a library of media posts, among other information. The user interface module 316 may send data to other modules of the augmented reality media timeline management and interaction application 108 of the client computing device 102, and retrieve data from other modules of the augmented reality media timeline management and interaction application 108 of the client computing device 102 asynchronously without interfering with the display and behavior of the user interface displayed by the client computing device 102.

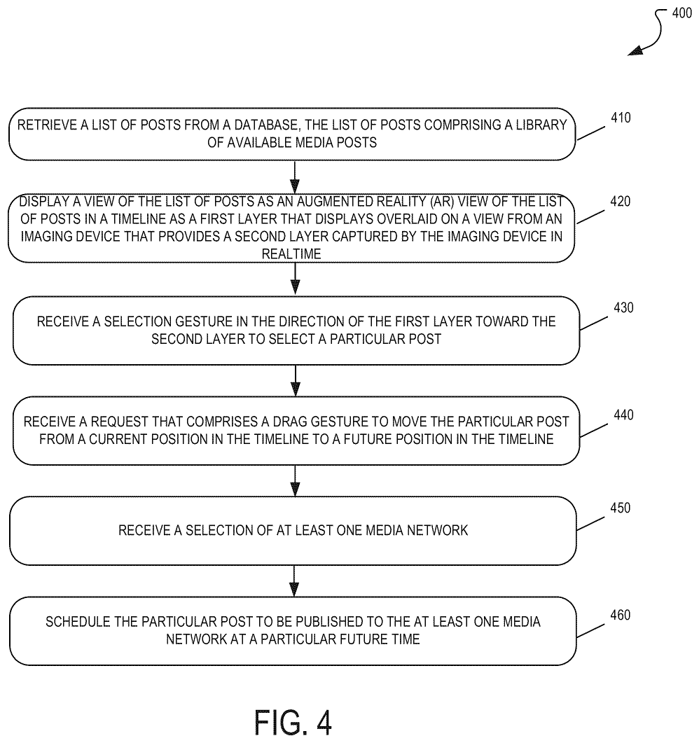

FIG. 4 illustrates an example method of scheduling a particular post to be published to at least one media network in augmented reality (AR) according to an example of the instant disclosure. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, the method 400 may include retrieving a list of posts from the database 110, the list of posts comprising a library of available media posts 202 at block 410.

Next, according to some examples, the method 400 may include displaying a view of the list of posts as an augmented reality (AR) view of the list of posts in a timeline as a first layer that displays overlaid on a view from an imaging device of the client computing device 102 that provides a second layer captured by the imaging device in realtime at block 420. As an example, each post in the timeline view can be displayed as a three-dimensional user interface element in the first layer in the augmented reality view, each post having a front side, a right side, a left side, a top side, and a bottom side, the front side displaying content associated with the post, at least one of the front side, the right side, the left side, the top side, and the bottom side of each post in the timeline viewable in a gallery view of the list of posts depending on a particular viewpoint, each post in the list of posts hung on a virtual wall associated with the first layer.

Next, according to some examples, the method 400 may include receiving a tap or selection gesture in the direction of the first layer toward the second layer to select a particular media post at block 430.

Next, according to some examples, the method 400 may include receiving a request that comprises a drag gesture and movement to move the particular media post from a current position in the timeline to a future position in the timeline at block 440. As an example, the augmented reality view can indicate when the post is scheduled to post after a current time by displaying at least one indicator that is pinned to a corner of the three-dimensional user interface element.

Next, according to some examples, the method 400 may include receiving a selection of at least one media network or platform at block 450.

Next, according to some examples, the method 400 may include scheduling the particular post to be published to the least one media network or platform at a particular future time based on the future position in the timeline at block 460.

According to some examples, the method 400 may include displaying the at least one indicator on the corner of the three-dimensional user interface element that moves in response to user input in realtime when the post moves from the current position in the timeline to the future position in the timeline.

According to some examples, the method 400 may include displaying the at least one indicator that moves in an opposite direction from the user input.

According to some examples, the method 400 may include displaying the at least one indicator that moves in an opposite direction from the user input, the at least one indicator having a length that is based on an acceleration of the user input.

According to some examples, the method 400 may include receiving the user input as a first input from a first computing device and receiving a second user input from a second computing device, and displaying at least one indicator on a corner of a different three-dimensional user interface element that moves in response to the second user input in realtime when the corresponding post moves from the current position in the timeline to the future position in the timeline.

According to some examples, the method 400 may include displaying a line that connects each post in the list of posts in the timeline view.

According to some examples, the method 400 may include displaying each post in the list of posts hung on the virtual wall associated with the first layer on a first three-dimensional curved wall and receive the request to move the particular post from a fixed position on the first three-dimensional curved wall to the future position on a second three-dimensional curved wall.

According to some examples, the method 400 may include displaying a third semi-transparent layer having a particular color between the three-dimensional user interface element in the first layer and the second layer indicating the post is scheduled after the current time.

According to some examples, the method 400 may include displaying at least one of the front side, the right side, the left side, the top side, and the bottom side of each post in the timeline in a gallery view of the list of posts depending on a viewpoint, each post in the list of posts hung on a virtual wall associated with the first layer.

According to some examples, the method 400 may include displaying an outline on each post, the outline displayed in a particular color that represents a particular media network.

According to some examples, the method 400 may include displaying a first post in a first sub-layer of the first layer over a second post in a second sub-layer of the first layer when the first post and the second post are from a same particular period of time.

According to some examples, the method 400 may include displaying a date of each post in the gallery view of the list of posts, the date displayed on the front side of each post.

According to some examples, the method 400 may include receiving a request to initiate multiplayer mode and connecting more than one user to the AR view of the list of posts to manage and interact with the list of posts at a same time.

According to some examples, the method 400 may include displaying a user interface element of a first computing device that represents a user position of a first user in the augmented reality view and displaying an indicator that represents a direction of view for the first user in the augmented reality view.

According to some examples, the method 400 may include displaying a user interface element of a second computing device that represents a user position of a second user in the augmented reality view and displaying an indicator that represents a direction of view for the second user in the augmented reality view.

According to some examples, the method 400 may include receiving audio from a microphone of a computing device of a user in realtime and transmitting the audio to at least one other computing device of at least one other user.

According to some examples, the method 400 may include receiving more than one simultaneous selection of a particular post, each selection received from a different computing device.

According to some examples, the method 400 may include receiving more than one simultaneous request that comprises a drag gesture to move each particular post from a current position in the timeline to a future position in the timeline and simultaneously showing movement of each particular post to each of the more than one user.

According to some examples, the method 400 may include displaying a particular level of detail for each post on the front side for a user based on a particular distance of a position of a computing device for the user in the AR view.

According to some examples, the method 400 may include receiving a selection of one of a previous user interface element and a next user interface element and displaying information associated with posts to be published to the least one media network on a particular day.

FIG. 5 shows an example user interface 500 of the augmented reality media timeline management and interaction application 108 displayed by the client computing device 102 according to an example of the instant disclosure. As shown in FIG. 5, a user interface element associated with a first client computing device 102 and a first user is shown in the augmented reality view that also shows an example library of media posts 202.

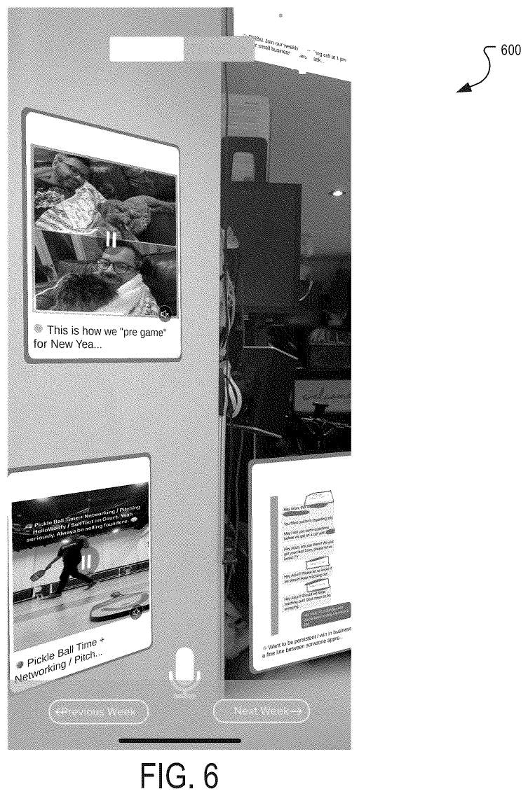

FIG. 6 shows an example user interface 600 of the augmented reality media timeline management and interaction application 108 displayed by the client computing device 102 according to an example of the instant disclosure. As shown in FIG. 6, a user can move in the augmented reality view closer toward the library of media posts 202. When the user moves within a particular distance of a post, additional information and data associated with the post may be shown on a front side of a user interface element associated with a post. For example, a first post shown in FIG. 6 may show one or more video clips that may play when the user is within the particular distance of the post and text associated with the post may be shown. Audio associated with one or more video clips may be provided to the client computing device and output by the client computing device 102. If the user moves to a distance greater than the particular distance, a thumbnail associated with the post may be displayed instead.

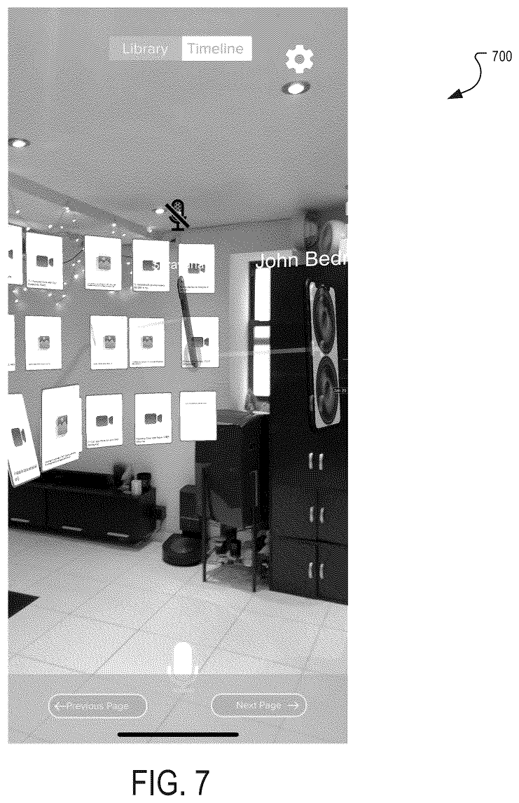

FIG. 7 shows an example user interface 700 of the augmented reality media timeline management and interaction application 108 displayed by the client computing device 102 according to an example of the instant disclosure. As shown in FIG. 7, the user of the client computing device 102 may have moved to a different location such that they have a different view of the library of media posts 202.

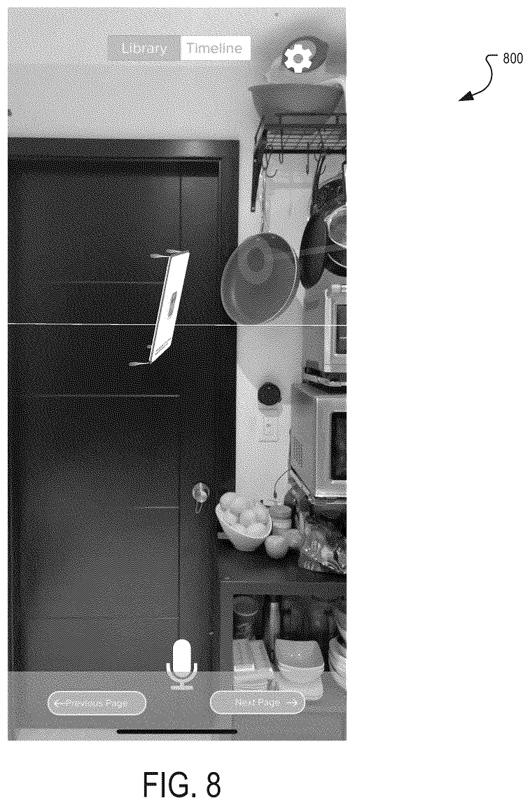

FIG. 8 shows an example user interface 800 of the augmented reality media timeline management and interaction application 108 displayed by the client computing device 102 according to an example of the instant disclosure. As shown in FIG. 8, a user of the client computing device 102 may have selected a particular media post and is in the process of moving the particular post to a portion or section of the augmented reality user interface as shown in FIGS. 2A and 2B. When the user moves the particular post to the portion or section of the augmented reality interface, e.g., from the present position 230 toward the future position 240, it can be scheduled to be published or posted at a particular time in the future 250.

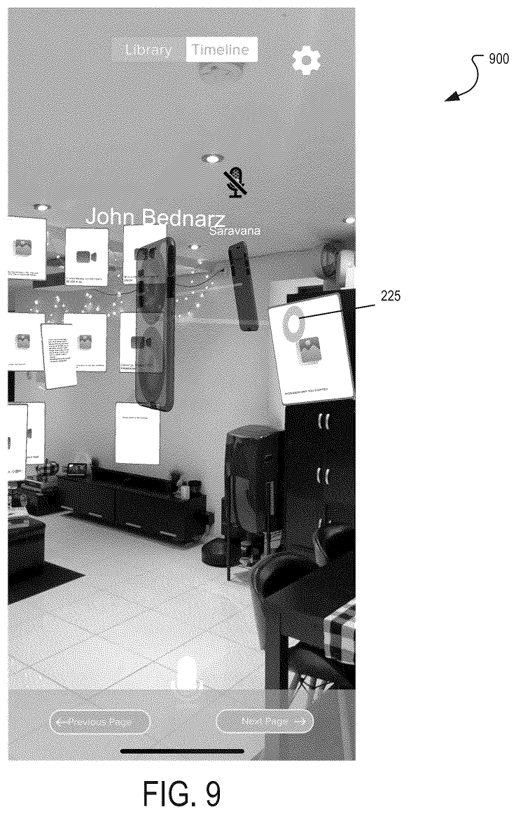

FIG. 9 shows an example user interface 900 of augmented reality media timeline management and interaction application 108 displayed by the client computing device 102 according to an example of the instant disclosure. As shown in FIG. 9, there may be a first user interface element associated with a first client computing device and a first user is shown in the augmented reality view that also shows an example library of media posts 202. Additionally, there may be a second user interface element associated with a second client computing device and a second user is shown in the augmented reality view.

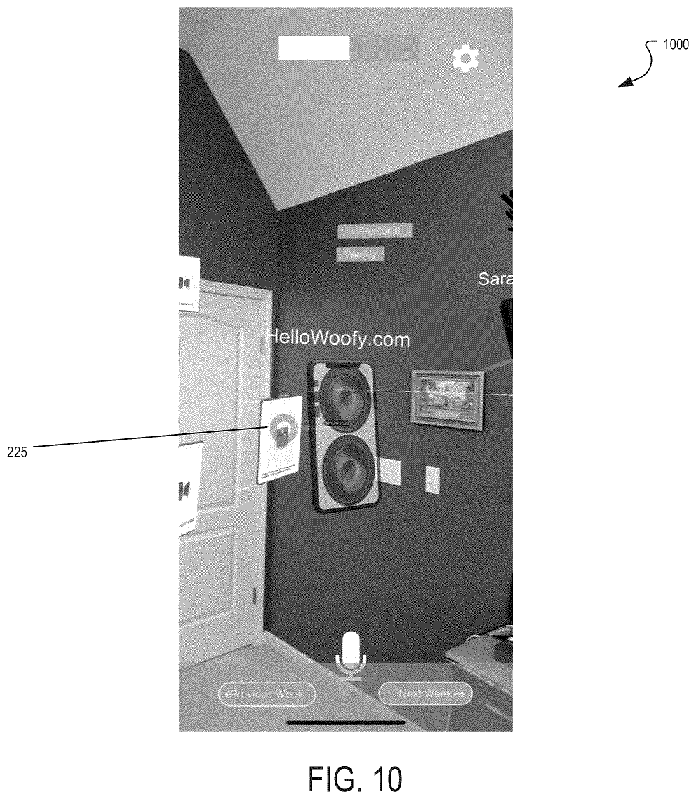

FIG. 10 shows an example user interface 1000 of the augmented reality media timeline management and interaction application 108 displayed by the client computing device 102 according to an example of the instant disclosure. As shown in FIG. 10, there may be a first user interface element 225 associated with a first client computing device 102 and a first user is shown in the augmented reality view that also shows an example library of media posts 202. Additionally, there may be a second user interface element 225 associated with a second client computing device 102 and a second user is shown in the augmented reality view. In this example, a user of a client computing device is pointing or directing a user interface element 225 toward a particular media post and may select the particular media post when the user interface element 225 is pointing toward the media post and the user touches the media post on the touchscreen of the client computing device 102.

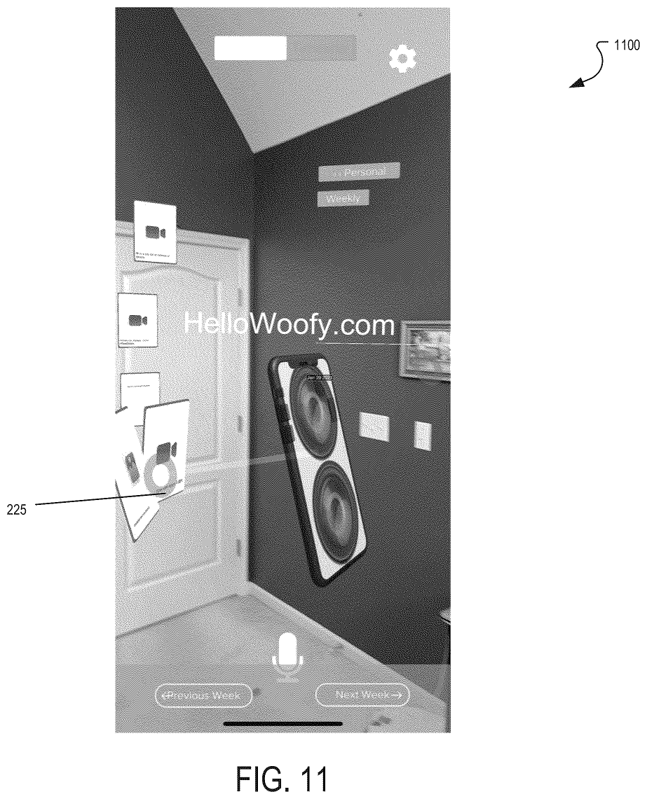

FIG. 11 shows an example user interface 1100 of the augmented reality media timeline management and interaction application 108 displayed by the client computing device 102 according to an example of the instant disclosure. As shown in FIG. 11, there may be a first user interface element 225 associated with a first client computing device 102 and a first user is shown in the augmented reality view that also shows an example library of media posts 202. In this example, a user of a client computing device is pointing or directing a user interface element 225 toward a particular media post and may select the particular media post when the user interface element 225 is pointing toward the media post and the user touches the media post on the touchscreen of the client computing device 102. As shown in FIG. 11, the user has moved the media post in a different location from where it was shown in FIG. 10.

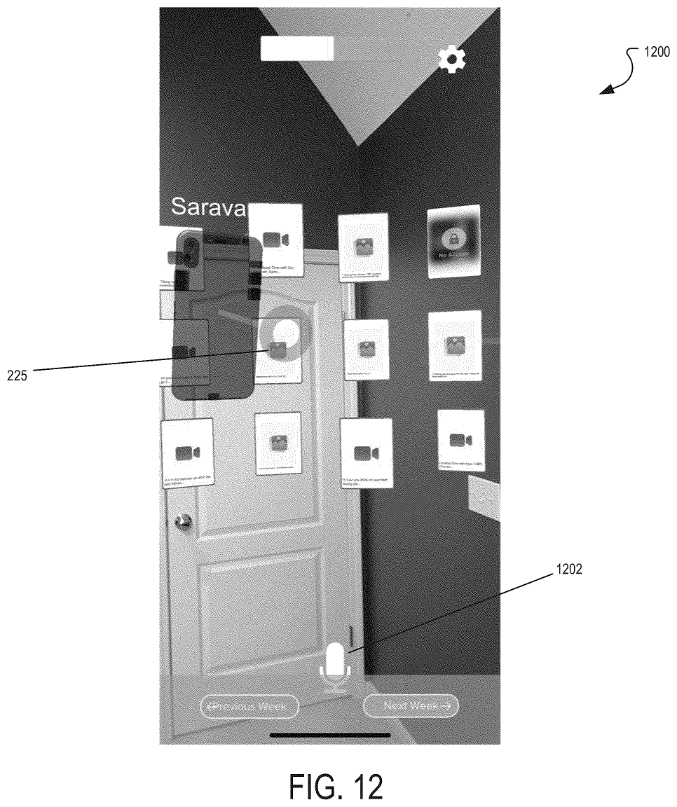

FIG. 12 shows an example user interface 1200 of the augmented reality media timeline management and interaction application 108 displayed by the client computing device 102 according to an example of the instant disclosure. As shown in FIG. 12, there may be a first user interface element 225 associated with a first client computing device 102 and a first user is shown in the augmented reality view that also shows an example library of media posts 202. In this example, a user of a client computing device 102 is pointing or directing a user interface element 225 toward a particular media post and may select the particular media post when the user interface element 225 is pointing toward the media post and the user touches the media post on the touchscreen of the client computing device 102. Additionally, as shown in FIG. 12, the user may select a user interface element 1202 associated with shared audio to transmit audio to the other users that may be simultaneously participating in viewing the library of media posts. As an example, the user may press the microphone on the touchscreen of the client computing device to transmit audio to the other users.

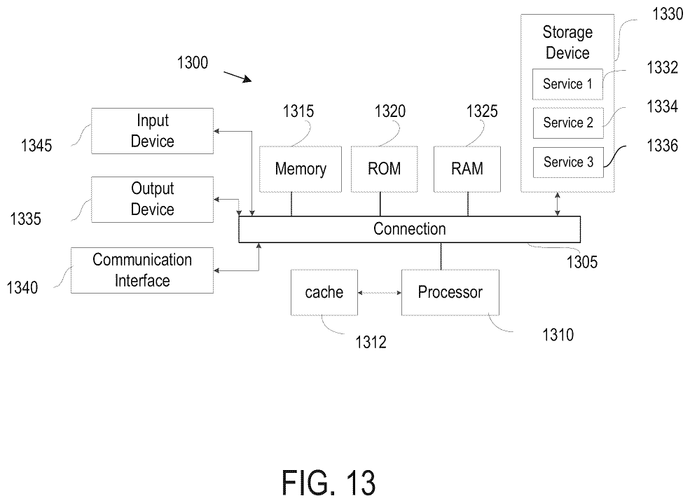

FIG. 13 shows an example of computing system 1300, which can be for example any computing device making up the computing device such as the client computing device 102, the server computing device 104, a smart speaker device, or any component thereof in which the components of the system are in communication with each other using connection 1305. Connection 1305 can be a physical connection via a bus, or a direct connection into processor 1310, such as in a chipset architecture. Connection 1305 can also be a virtual connection, networked connection, or logical connection.

In some embodiments, computing system 1300 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1300 includes at least one processing unit (CPU or processor) 1310 and connection 1305 that couples various system components including system memory 1315, such as read-only memory (ROM) 1320 and random access memory (RAM) 1325 to processor 1310. Computing system 1300 can include a cache of high-speed memory 1312 connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms known to those of skill in the art. In some instances, multimodal systems can enable a user to provide multiple types of input/output to communicate with computing system 1300. Computing system 1300 can include communications interface 1340, which can generally govern and manage the user input and system output. There is no restriction on operating on any particular hardware arrangement, and therefore the basic features here may easily be substituted for improved hardware or firmware arrangements as they are developed.

Storage device 1330 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1330 can include software services, servers, services, etc., that when the code that defines such software is executed by the processor 1310, it causes the system to perform a function. In some embodiments, a hardware service that performs a particular function can include the software component stored in a computer-readable medium in connection with the necessary hardware components, such as processor 1310, connection 1305, output device 1335, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per sc.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory. USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative examples of the disclosure include:
Aspect 1: A system comprising: a memory storing computer-readable instructions; and at least one processor to execute the instructions to retrieve a list of posts from a database, the list of posts comprising a library of available media posts including past posts and scheduled posts, display a view of the list of posts as an augmented reality (AR) view of the list of posts in a timeline as a first layer that displays overlaid on a view from an imaging device that provides a second layer captured by the imaging device in realtime, each post in the timeline view displayed as a three-dimensional user interface element in the first layer in the augmented reality view, each post having a front side, a right side, a left side, a top side, and a bottom side, the front side displaying content associated with the post, at least one of the front side, the right side, the left side, the top side, and the bottom side of each post in the timeline viewable in a gallery view of the list of posts depending on a particular viewpoint, each post in the list of posts hung on a virtual wall associated with the first layer, receive a selection gesture in the direction of the first layer toward the second layer to select a particular post, receive a request that comprises a drag gesture to move the particular post from a current position in the timeline to a future position in the timeline, the augmented reality view indicating when the post is scheduled to post after a current time by displaying at least one indicator that is pinned to a corner of the three-dimensional user interface element, receive a selection of at least one media network, and schedule the particular post to be published to the least one media network at a particular future time based on the future position in the timeline.
Aspect 2: The system of Aspect 1, the at least one processor further to display the at least one indicator on the corner of the three-dimensional user interface element that moves in response to user input in realtime when the post moves from the current position in the timeline to the future position in the timeline.
Aspect 3: The system of Aspects 1 and 2, the at least one processor further to display the at least one indicator that moves in an opposite direction from the user input.
Aspect 4: The system of Aspects 1 to 3, the at least one processor further to display the at least one indicator that moves in an opposite direction from the user input, the at least one indicator having a length that is based on an acceleration of the user input.
Aspect 5: The system of Aspects 1 to 4, the at least one processor further to receive the user input as a first input from a first computing device and receive a second user input from a second computing device, and display at least one indicator on a corner of a different three-dimensional user interface element that moves in response to the second user input in realtime when the corresponding post moves from the current position in the timeline to the future position in the timeline.
Aspect 6: The system of Aspects 1 to 5, the at least one processor further to display each post in the list of posts hung on the virtual wall associated with the first layer on a first three-dimensional curved wall and receive the request to move the particular post from a fixed position on the first three-dimensional curved wall to the future position on a second three-dimensional curved wall.
Aspect 7: The system of Aspects 1 to 6, the at least one processor further to display a third semi-transparent layer having a particular color between the three-dimensional user interface element in the first layer and the second layer indicating the post is scheduled after the current time.
Aspect 8: The system of Aspects 1 to 7, the at least one processor further to display at least one of the front side, the right side, the left side, the top side, and the bottom side of each post in the timeline in a gallery view of the list of posts depending on a viewpoint, each post in the list of posts hung on a virtual wall associated with the first layer.
Aspect 9: The system of Aspects 1 to 8, the at least one processor further to display an outline on each post, the outline displayed in a particular color that represents a particular media network.
Aspect 10: The system of Aspects 1 to 9, the at least one processor further to display a first post in a first sub-layer of the first layer over a second post in a second sub-layer of the first layer when the first post and the second post are from a same particular period of time.
Aspect 11: The system of Aspects 1 to 10, the at least one processor further to display a date of each post in the gallery view of the list of posts, the date displayed on the front side of each post.
Aspect 12: The system of Aspects 1 to 11, the at least one processor further to receive a request to initiate multiplayer mode and connect more than one user to the AR view of the list of posts to manage and interact with the list of posts at a same time.
Aspect 13: The system of Aspects 1 to 12, the at least one processor further to display a user interface element of a first computing device that represents a user position of a first user in the augmented reality view and display an indicator that represents a direction of view for the first user in the augmented reality view.
Aspect 14: The system of Aspects 1 to 13, the at least one processor further to display a user interface element of a second computing device that represents a user position of a second user in the augmented reality view and display an indicator that represents a direction of view for the second user in the augmented reality view.
Aspect 15: The system of Aspects 1 to 14, the at least one processor further to receive audio from a microphone of a computing device of a user in realtime and transmit the audio to at least one other computing device of at least one other user.
Aspect 16: The system of Aspects 1 to 15, the at least one processor further to receive more than one simultaneous selection of a particular post, each selection received from a different computing device.
Aspect 17: The system of Aspects 1 to 16, the at least one processor further to receive more than one simultaneous request that comprises a drag gesture to move each particular post from a current position in the timeline to a future position in the timeline and simultaneously show movement of each particular post to each of the more than one user.
Aspect 18: The system of Aspects 1 to 17, the at least one processor further to display a particular level of detail for each post on the front side for a user based on a particular distance of a position of a computing device for the user in the AR view.
Aspect 19: The system of Aspects 1 to 18, the at least one processor further to receive a selection of one of a previous user interface element and a next user interface element and display information associated with posts to be published to the least one media network on a particular day.
Aspect 20: A method including retrieving, by at least one processor, a list of posts from a database, the list of posts comprising a library of available media posts including past posts and scheduled posts, displaying, by the at least one processor, a view of the list of posts as an augmented reality (AR) view of the list of posts in a timeline as a first layer that displays overlaid on a view from an imaging device that provides a second layer captured by the imaging device in realtime, each post in the timeline view displayed as a three-dimensional user interface element in the first layer in the augmented reality view, each post having a front side, a right side, a left side, a top side, and a bottom side, the front side displaying content associated with the post, at least one of the front side, the right side, the left side, the top side, and the bottom side of each post in the timeline viewable in a gallery view of the list of posts depending on a particular viewpoint, each post in the list of posts hung on a virtual wall associated with the first layer, receiving, by the at least one processor, a selection gesture in the direction of the first layer toward the second layer to select a particular post, receiving, by the at least one processor, a request that comprises a drag gesture to move the particular post from a current position in the timeline to a future position in the timeline, the augmented reality view indicating when the post is scheduled to post after a current time by displaying at least one indicator that is pinned to a corner of the three-dimensional user interface element, receiving, by the at least one processor, a selection of at least one media network, and scheduling, by the at least one processor, the particular post to be published to the least one media network at a particular future time based on the future position in the timeline.
Aspect 21: A non-transitory computer-readable storage medium comprising instructions stored thereon that, when executed by a computing device cause the computing device to perform operations, the operations comprising retrieving a list of posts from a database, the list of posts comprising a library of available media posts including past posts and scheduled posts, displaying a view of the list of posts as an augmented reality (AR) view of the list of posts in a timeline as a first layer that displays overlaid on a view from an imaging device that provides a second layer captured by the imaging device in realtime, each post in the timeline view displayed as a three-dimensional user interface element in the first layer in the augmented reality view, each post having a front side, a right side, a left side, a top side, and a bottom side, the front side displaying content associated with the post, at least one of the front side, the right side, the left side, the top side, and the bottom side of each post in the timeline viewable in a gallery view of the list of posts depending on a particular viewpoint, each post in the list of posts hung on a virtual wall associated with the first layer, receiving a selection gesture in the direction of the first layer toward the second layer to select a particular post, receiving a request that comprises a drag gesture to move the particular post from a current position in the timeline to a future position in the timeline, the augmented reality view indicating when the post is scheduled to post after a current time by displaying at least one indicator that is pinned to a corner of the three-dimensional user interface element, receiving a selection of at least one media network, and scheduling the particular post to be published to the least one media network at a particular future time based on the future position in the timeline.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A system comprising:
a memory storing computer-readable instructions; and
at least one processor to execute the instructions to:
retrieve a list of posts from a database, the list of posts comprising a library of available media posts including past posts and scheduled posts;
display a view of the list of posts as an augmented reality (AR) view of the list of posts in a timeline as a first layer that displays overlaid on a view from an imaging device that provides a second layer captured by the imaging device in realtime, each post in the timeline view displayed as a three-dimensional user interface element in the first layer in the augmented reality view, each post having a front side, a right side, a left side, a top side, and a bottom side, the front side displaying content associated with the post, at least one of the front side, the right side, the left side, the top side, and the bottom side of each post in the timeline viewable in a gallery view of the list of posts depending on a particular viewpoint, each post in the list of posts hung on a virtual wall associated with the first layer;
receive a selection gesture in the direction of the first layer toward the second layer to select a particular post;
receive a request that comprises a drag gesture to move the particular post from a current position in the timeline to a future position in the timeline, the augmented reality view indicating when the post is scheduled to post after a current time by displaying at least one indicator that is pinned to a corner of the three-dimensional user interface element;
receive a selection of at least one media network; and
schedule the particular post to be published to the least one media network at a particular future time based on the future position in the timeline.

2. The system of claim 1, the at least one processor further to execute the instructions to display the at least one indicator on the corner of the three-dimensional user interface element that moves in response to user input in realtime when the post moves from the current position in the timeline to the future position in the timeline.

3. The system of claim 2, the at least one processor further to execute the instructions to display the at least one indicator that moves in an opposite direction from the user input.

4. The system of claim 3, the at least one processor further to execute the instructions to display the at least one indicator that moves in an opposite direction from the user input, the at least one indicator having a length that is based on an acceleration of the user input.

5. The system of claim 2, the at least one processor further to receive the user input as a first input from a first computing device and receive a second user input from a second computing device, and display at least one indicator on a corner of a different three-dimensional user interface element that moves in response to the second user input in realtime when the corresponding post moves from the current position in the timeline to the future position in the timeline.

6. The system of claim 1, the at least one processor further to display each post in the list of posts hung on the virtual wall associated with the first layer on a first three-dimensional curved wall and receive the request to move the particular post from a fixed position on the first three-dimensional curved wall to the future position on a second three-dimensional curved wall.

7. The system of claim 1, the at least one processor further to execute the instructions to display a third semi-transparent layer having a particular color between the three-dimensional user interface element in the first layer and the second layer indicating the post is scheduled after the current time.

8. The system of claim 1, the at least one processor further to display at least one of the front side, the right side, the left side, the top side, and the bottom side of each post in the timeline in a gallery view of the list of posts depending on a viewpoint, each post in the list of posts hung on a virtual wall associated with the first layer.

9. The system of claim 1, the at least one processor further to display an outline on each post, the outline displayed in a particular color that represents a particular media network.

10. The system of claim 1, the at least one processor further to display a first post in a first sub-layer of the first layer over a second post in a second sub-layer of the first layer when the first post and the second post are from a same particular period of time.

11. The system of claim 1, the at least one processor to display a date of each post in the gallery view of the list of posts, the date displayed on the front side of each post.

12. The system of claim 1, the at least one processor further to receive a request to initiate multiplayer mode and connect more than one user to the AR view of the list of posts to manage and interact with the list of posts at a same time.

13. The system of claim 12, the at least one processor further to display a user interface element of a first computing device that represents a user position of a first user in the augmented reality view and display an indicator that represents a direction of view for the first user in the augmented reality view.

14. The system of claim 13, the at least one processor further to display a user interface element of a second computing device that represents a user position of a second user in the augmented reality view and display an indicator that represents a direction of view for the second user in the augmented reality view.

15. The system of claim 14, the at least one processor further to receive audio from a microphone of a computing device of a user in realtime and transmit the audio to at least one other computing device of at least one other user.

16. The system of claim 15, the at least one processor further to receive more than one simultaneous selection of a particular post, each selection received from a different computing device.

17. The system of claim 16, the at least one processor further to receive more than one simultaneous request that comprises a drag gesture to move each particular post from a current position in the timeline to a future position in the timeline and simultaneously show movement of each particular post to each of the more than one user.

18. The system of claim 17, the at least one processor further to display a particular level of detail for each post on the front side for a user based on a particular distance of a position of a computing device for the user in the AR view.

19. The system of claim 1, the at least one processor further to receive a selection of one of a previous user interface element and a next user interface element and display information associated with posts to be published to the least one media network on a particular day.

20. A method, comprising:
retrieving, by at least one processor, a list of posts from a database, the list of posts comprising a library of available media posts including past posts and scheduled posts;
displaying, by the at least one processor, a view of the list of posts as an augmented reality (AR) view of the list of posts in a timeline as a first layer that displays overlaid on a view from an imaging device that provides a second layer captured by the imaging device in realtime, each post in the timeline view displayed as a three-dimensional user interface element in the first layer in the augmented reality view, each post having a front side, a right side, a left side, a top side, and a bottom side, the front side displaying content associated with the post, at least one of the front side, the right side, the left side, the top side, and the bottom side of each post in the timeline viewable in a gallery view of the list of posts depending on a particular viewpoint, each post in the list of posts hung on a virtual wall associated with the first layer;
receiving, by the at least one processor, a selection gesture in the direction of the first layer toward the second layer to select a particular post;
receiving, by the at least one processor, a request that comprises a drag gesture to move the particular post from a current position in the timeline to a future position in the timeline, the augmented reality view indicating when the post is scheduled to post after a current time by displaying at least one indicator that is pinned to a corner of the three-dimensional user interface element;
receiving, by the at least one processor, a selection of at least one media network; and
scheduling, by the at least one processor, the particular post to be published to the least one media network at a particular future time based on the future position in the timeline.

21. A non-transitory computer-readable storage medium comprising instructions stored thereon that, when executed by a computing device cause the computing device to perform operations, the operations comprising:
retrieving a list of posts from a database, the list of posts comprising a library of available media posts including past posts and scheduled posts;
displaying a view of the list of posts as an augmented reality (AR) view of the list of posts in a timeline as a first layer that displays overlaid on a view from an imaging device that provides a second layer captured by the imaging device in realtime, each post in the timeline view displayed as a three-dimensional user interface element in the first layer in the augmented reality view, each post having a front side, a right side, a left side, a top side, and a bottom side, the front side displaying content associated with the post, at least one of the front side, the right side, the left side, the top side, and the bottom side of each post in the timeline viewable in a gallery view of the list of posts depending on a particular viewpoint, each post in the list of posts hung on a virtual wall associated with the first layer;
receiving a selection gesture in the direction of the first layer toward the second layer to select a particular post;
receiving a request that comprises a drag gesture to move the particular post from a current position in the timeline to a future position in the timeline, the augmented reality view indicating when the post is scheduled to post after a current time by displaying at least one indicator that is pinned to a corner of the three-dimensional user interface element;
receiving a selection of at least one media network; and
scheduling the particular post to be published to the least one media network at a particular future time based on the future position in the timeline.
